(19) United States
(12) Patent Application Publication
(10) Pub. No.: US 2015/0167979 A1
(43) Pub. Date: Jun. 18, 2015

(54) FIRST STAGE NOZZLE OR TRANSITION NOZZLE CONFIGURED TO PROMOTE MIXING OF RESPECTIVE COMBUSTION STREAMS DOWNSTREAM THEREOF BEFORE ENTRY INTO A FIRST STAGE BUCKET OF A TURBINE

(71) Applicant: General Electric Company, Schenectady, NY (US)

(72) Inventors: Gunnar Leif Siden, Greenville, SC (US); Scott Matthew Sparks, Simpsonville, SC (US); Clint L. Ingram, Greenville, SC (US); Sylvain Pierre, Greenville, SC (US); Neil Ristau, Simpsonville, SC (US)

(73) Assignee: General Electric Company, Schenectady, NY (US)

(21) Appl. No.: 14/109,418

(22) Filed: Dec. 17, 2013

(51) Int. Cl. F23R 3/16; F01D 9/02; F23R 3/46

(52) U.S. Cl. CPC F23R 3/16; F23R 3/46; F01D 9/023; F23R 2900/03282; F05D 2240/122; F05D 2240/127; F05D 2250/183; F05D 2250/184

(57) ABSTRACT

The present application and the resultant patent provide a disruptive surface on a trailing edge of a stage one nozzle or transition nozzle to promote mixing of respective combustion streams downstream thereof before entry into a first stage bucket of a turbine. For example, in one embodiment, a gas turbine engine may include a combustor having a combustion flow. The gas turbine engine also may include one or more airfoils forming a first stage nozzle or s transition nozzle disposed downstream of the combustor. Moreover, the gas turbine engine may include a flow disruption surface positioned about a trailing edge of the one or more airfoils to promote mixing of the combustion flow.

### FIELD OF THE DISCLOSURE

The present application relates generally to gas turbine engines and more particularly relates to a trailing edge of a first stage nozzle or a transition nozzle configured to promote mixing of respective combustion streams downstream thereof before entry into a first stage bucket of a turbine.

### BACKGROUND

Annular combustors often are used with gas turbine engines. Generally described, an annular combustor may have a number of individual can combustors that are circumferentially spaced between a compressor and a turbine. Each can combustor separately generates combustion gases that are directed downstream towards the first stage of the turbine.

The mixing of these separate combustion streams is largely a function of the free stream Mach number at which the mixing is taking place as well as the differences in momentum and energy between the combustion streams. Practically speaking, the axial distance between the exit of the can combustors and the leading edge of a first stage nozzle is relatively small such that little mixing actually may take place before entry into the turbine.

There is thus a desire to minimize mixing loses. Such reduced mixing loses may reduce overall pressure losses without increasing the axial distance between the combustor and the turbine. Such an improved combustion design thus should improve overall system performance and efficiency.

### SUMMARY

The present application and the resultant patent thus provide a disruptive surface on a trailing edge of a stage one nozzle or a transition nozzle to promote mixing of respective combustion streams downstream thereof before entry into a first stage bucket of a turbine. For example, in one embodiment, a gas turbine engine may include a combustor including a combustion flow. The gas turbine engine also may include one or more airfoils forming a first stage nozzle or a transition nozzle disposed downstream of the combustor. Moreover, the gas turbine engine may include a flow disruption surface positioned about a trailing edge of the one or more airfoils to promote mixing of the combustion flow.

The present application and the resultant patent further provides a method of limiting pressure losses in a gas turbine engine. The method may include positioning a flow disruption surface on a trailing edge of one or more airfoils of a first stage nozzle or a transition nozzle, generating a number of combustion streams in a number of can combustors, substantially mixing the combustion streams with the flow disruption surface, and passing a mixed stream to a stage one bucket.

The present application and the resultant patent further provides a gas turbine engine. The gas turbine engine may include a number of can combustors forming a number of combustion flows. The gas turbine engine also may include one or more airfoils forming a first stage nozzle or a transition nozzle disposed downstream of the can combustors. Moreover, the gas turbine may include a flow disruption surface positioned about a trailing edge of the one or more airfoils to promote mixing of the combustion flows.

These and other features and improvements of the present application will become apparent to one of ordinary skill in the art upon review of the following detailed description when taken in conjunction with the several drawings and the appended claims.

### BRIEF DESCRIPTION OF THE DRAWINGS

Reference will now be made to the accompanying drawings, which are not necessarily drawn to scale.

FIG. 1 is a schematic view of a known gas turbine engine that may be used herein.

FIG. 2 is a side cross-sectional view of a can combustor that may be used with the gas turbine engine of FIG. 1.

FIG. 3 is a side cross-sectional view of a transition nozzle combustion system that may be used with the gas turbine engine of FIG. 1.

FIG. 4 is a schematic view of a nozzle as may be described herein.

FIG. 5 is a schematic view of a flow disruption surface as may be described herein.

FIG. 6 is a schematic view of a flow disruption surface as may be described herein.

FIG. 7 is a schematic view of a flow disruption surface as may be described herein.

### DETAILED DESCRIPTION

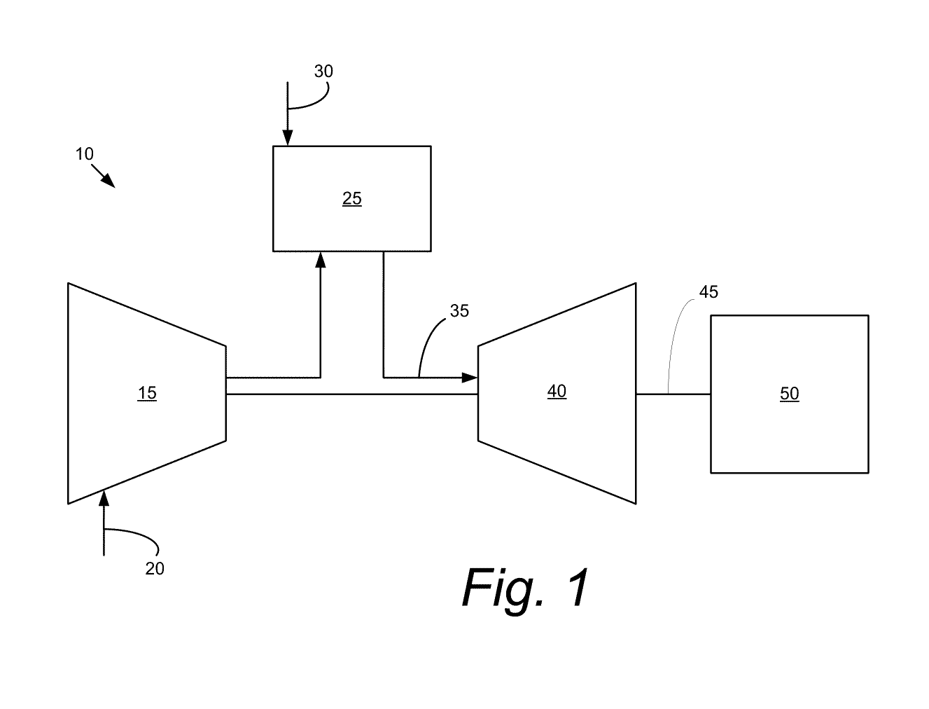

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. In this example, the combustor 25 may be in the form of a number of can combustors as will be described in more detail below. The flow of combustion gases 35 is in turn delivered to a downstream turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, and/or other types of fuels. The gas turbine engine 10 may be anyone of a number of different gas turbine engines such as those offered by General Electric Company of Schenectady, New York and the like. The gas turbine engine 10 may have different configurations and may use other types of components. Other types of gas turbine engines also may be used herein. Multiple gas turbine engines, other types of turbines, and other types of power generation equipment also may be used herein together.

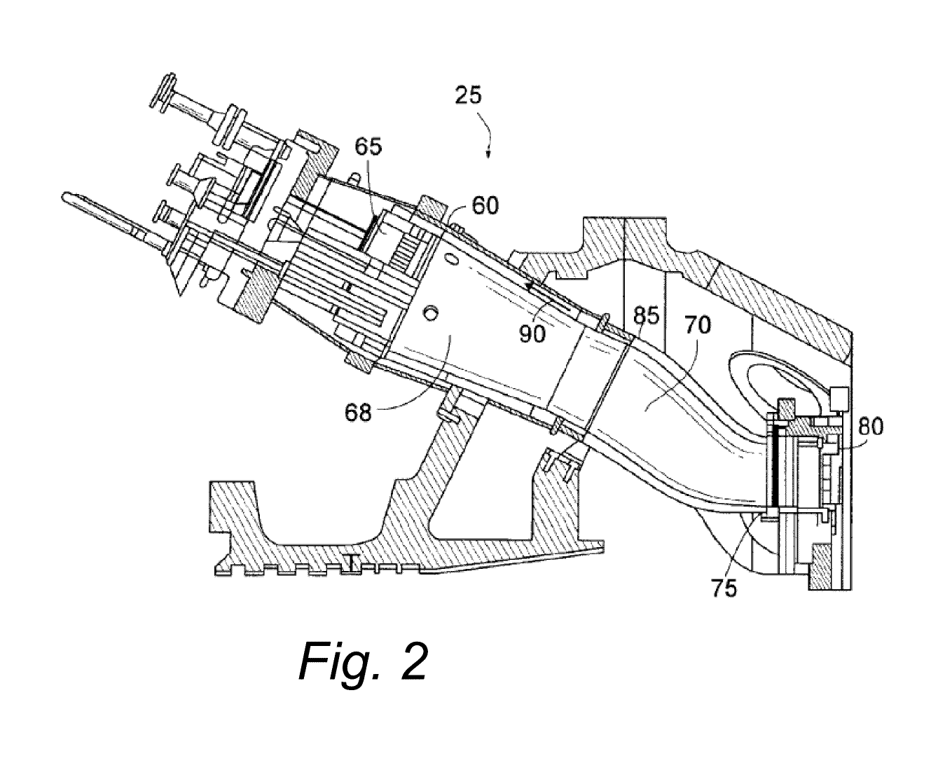

FIG. 2 shows an example of the combustion system 25 that may be used in the gas turbine engine 10. A typical combustion system 25 may include a head end 60 with a number of fuel nozzles 65. A liner 68 and a transition piece 70 may extend downstream of the fuel nozzles 65 to an aft end 75 about a number of first stage nozzle vanes 80 of the turbine 40. An impingement sleeve 85 may surround the liner 68 and the transition piece 70 and provide a cooling flow thereto. Other types of combustors 25 and other types of components and other configurations are also known.

A cooling flow 90 from the compression system 15 or elsewhere may pass through the impingement sleeve 85. The cooling flow 90 may be used to cool the liner 68 and the transition piece 70 and then may be used at least in part in charging the flow of combustion gases 35. A portion of the flow 90 may head towards the aft end 75 and may be used for cooling the first stage nozzle vanes 80 and related components. Other types of cooling flows may be used. The loss of a portion of the cooling flow 90 thus results in a parasitic loss because that portion of the flow 90 is not used for charging the combustion flow 35. Other components and other configurations also may be used herein.

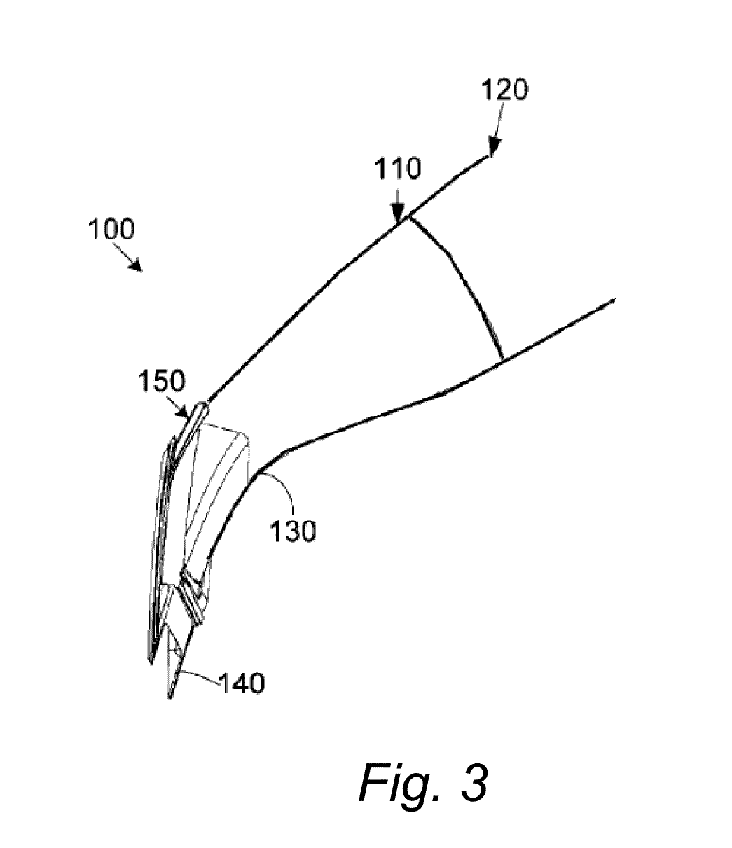

FIG. 3 shows an example of a portion of a transition nozzle combustion system 100 as may be described herein. The transition nozzle combustion system 100 may include a transition nozzle 110. The transition nozzle 110 has an integrated configuration of a liner, a transition piece, and a first stage nozzle vane in a manner similar to that described above. The transition nozzle 110 extends from a head end 120 about the fuel nozzles 65 to a flow region 130 and a transition nozzle aft end 140 about a number of bucket blades in a first turbine stage 150. The transition nozzle combustion system 100 thus may be considered an integrated combustion system. Other types of combustors in other configurations may be used herein.

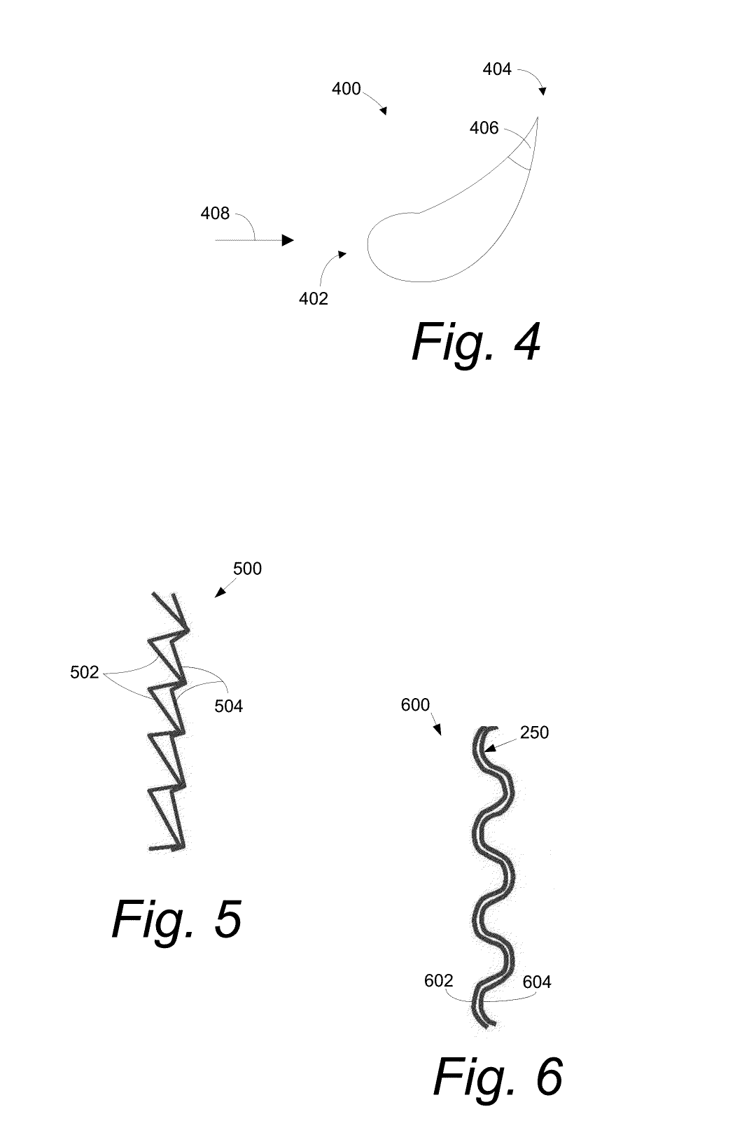

In certain embodiments, as depicted in FIG. 4, the trailing edge (i.e., downstream edge) of the first stage nozzle vanes 80 and/or the transition nozzles 110 may include a flow disruption surface to promote mixing of the combustion flows. That is, the trailing edge of the first stage nozzle vanes 80 and/or the transition nozzles 110 may include a chevron mixing component, a lobed mixing component, and/or a fluidics mixing component. In this manner, the trailing edge shape of the first stage nozzle vanes 80 and/or the transition nozzles 110 may be configured to promote mixing of the combustion flow such that the overall pressure loss of the system is reduced. As a result, the trailing edge shape of the first stage nozzle vanes 80 and/or the transition nozzles 110 may reduce the high cycle fatigue load and the heat load on the first stage buckets. The first stage nozzle vanes 80 and/or the transition nozzles 110 may or may not be integral with the transition piece and/or with the combustor.

FIG. 4 shows an embodiment of an airfoil 400 of a first stage nozzle 80 and/or a transition nozzle 110. In one example, the airfoil 400 of the first stage nozzle may include a leading edge 402 and a trailing edge 404. The trailing edge 404 may include a flow disruption surface 406. The flow disruption surface may be configured to promote mixing of the combustion flows 408. That is, the flow disruption surface may be configured to promote mixing of the combustion flows 408 downstream thereof before entry into a first stage bucket. The flow disruption surface 406 may include spikes, chevrons, lobes, and/or jets.

The increased uniformity of the temperature and velocity field created by the enhanced mixing of the trailing edge 404 disruption surface 406 of the airfoils 400 of the first stage nozzle and/or the transition nozzle is beneficial to the rotor blade row mechanical and thermal durability downstream thereof. This is particularly beneficial for a low nozzle count or a transition-nozzle configuration. The enhanced mixing is created by the use of spikes, chevrons, lobes, and/or jets disposed about the trailing edge 404 of the airfoils 400 of the first stage nozzle. This enhanced mixing increases the pressure loss relative to unforced mixing. The addition of the flow disruption surface 406 about the trailing edge 404 of the airfoils 400 of the first stage nozzle and/or the transition nozzle minimizes the amount of mixing that takes place within the bucket domain. The additional pressure loss incurred by the enhanced mixing from the trailing edge 404 of the airfoils 400 of the first stage nozzle and/or the transition nozzle is much lower than the mixing loss incurred should the nozzle wake mix in the downstream bucket. Also, the enhanced mixing reduces the wake strength of the nozzle and the high cycle fatigue loads on the bucket, which allows more economical nozzle configurations to be chosen (such as, but not limited to, lower count and/or closer axial nozzle-bucket spacing). Further, the enhanced mixing makes the incoming velocity and thermal flow distributions more uniform, which reduces the gas loads and thermal loads on the bucket, thereby improving the durability of the bucket.

FIGS. 5-7 show a number of different embodiments of the flow disruption surface 406 of FIG. 4 as may be described herein. For example, as depicts in FIG. 5, the flow disruption surface 406 of FIG. 4 may be a chevron mixing joint 500. In some instances, the chevron mixing joint 500 may include a first set of chevron like spikes 502 and a mating second set of chevron like spikes 504. As is shown, the depth and angle of the first and second set of chevron like spikes 502, 504 may vary. Likewise, the number, size, shape, and configuration of the chevron like spikes 502, 504 each may vary. Other components and other configurations may be used herein.

FIG. 6 shows a further embodiment of the flow disruption surface 406 of FIG. 4 as may be described herein. In this embodiment, a lobed mixing joint 600 is shown. The lobed mixing joint 600 may include a first set of lobes 602 and a second set of lobes 604. The first and second set of lobes 602, 604 may have a largely sinusoidal wave like shape and may mate therewith. The depth and shape of the first and second set of lobes 602, 604 also may vary. The number, size, shape, and configuration of the lobes 602, 604 may vary. Other components and configurations may be used herein.

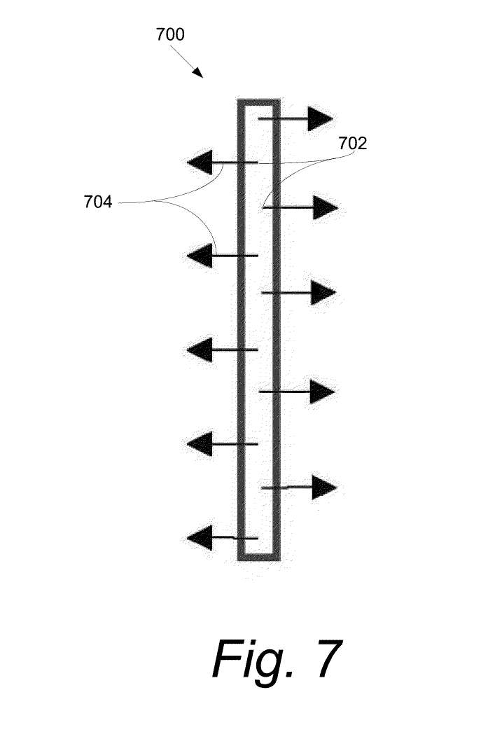

FIG. 7 shows a further embodiment of the flow disruption surface 406 of FIG. 4. In this example, the flow disruption surface 406 of FIG. 4 may be in the form of a fluidics mixing joint 700 as is shown. The fluidics mixing joint 700 may include a number of jets 702 therein that act as the flow disruption surface 406. The jets 702 may spray a fluid 704 into the combustion flows. The number, size, shape, and configuration of the jets 702 may vary. Likewise, the nature of the fluid 704 may vary. Other components and configurations may be used herein.

The embodiments of the flow disruption surface described herein are for purposes of example only. Any other the flow disruption surface geometry or other type of flow disruption surface that encourages mixing of the combustion flows may be used herein. Different types of flow disruption surfaces may be used herein together. Other components and other configurations also may be used herein.

It should be apparent that the foregoing relates only to certain embodiments of the present application and that numerous changes and modifications may be made herein by one of ordinary skill in the art without departing from the general spirit and scope of the disclosure as defined by the following claims and the equivalents thereof

That which is claimed is:

1. A gas turbine engine, comprising:
a combustor comprising one or more combustion flows;
one or more airfoils forming a first stage nozzle or a transition nozzle disposed downstream of the combustor; and
a flow disruption surface positioned about a trailing edge of the one or more airfoils to promote mixing of the one or more combustion flows.

2. The gas turbine engine of claim 1, wherein the flow disruption surface comprises a first set of spikes and a second set of spikes.

3. The gas turbine engine of claim 2, wherein the first set of spikes and the second set of spikes comprise differing depths.

4. The gas turbine engine of claim 2, wherein the first set of spikes and the second set of spikes comprise a chevron like spike.

5. The gas turbine engine of claim 1, wherein the flow disruption surface comprises a first set of lobes and a second set of lobes.

6. The gas turbine engine of claim 5, wherein the first set of lobes and the second set of lobes comprise differing depths.

7. The gas turbine engine of claim 5, wherein the first set of lobes and the second set of lobes comprise a sinusoidal like shape.

8. The gas turbine engine of claim 1, wherein the flow disruption surface comprises a plurality of jets.

9. The gas turbine engine of claim 8, further comprising a fluid spraying from the plurality of jets.

10. The gas turbine engine of claim 1, further comprising a first stage bucket positioned downstream of the first stage nozzle or the transition nozzle.

11. A method, comprising:
positioning a flow disruption surface on a trailing edge of one or more airfoils of a first stage nozzle or a transition nozzle;
generating a plurality of combustion streams in a plurality of can combustors;
substantially mixing the plurality of combustion streams with the flow disruption surface; and
passing a mixed stream to a stage one bucket.

12. A gas turbine engine, comprising:
a plurality of can combustors forming a plurality of combustion flows;
one or more airfoils forming a first stage nozzle or a transition nozzle disposed downstream of the plurality of can combustors; and
a flow disruption surface positioned about a trailing edge of the one or more airfoils to promote mixing of the plurality of combustion flows.

13. The gas turbine engine of claim 12, wherein the flow disruption surface comprises a first set of spikes and a second set of spikes.

14. The gas turbine engine of claim 13, wherein the first set of spikes and the second set of spikes comprise differing depths.

15. The gas turbine engine of claim 13, wherein the first set of spikes and the second set of spikes comprise a chevron like spike.

16. The gas turbine engine of claim 12, wherein the flow disruption surface comprises a first set of lobes and a second set of lobes.

17. The gas turbine engine of claim 16, wherein the first set of lobes and the second set of lobes comprise differing depths.

18. The gas turbine engine of claim 16, wherein the first set of lobes and the second set of lobes comprise a sinusoidal like shape.

19. The gas turbine engine of claim 12, wherein the flow disruption surface comprises a plurality of jets.

20. The gas turbine engine of claim 12, further comprising a first stage bucket positioned downstream of the first stage nozzle or the transition nozzle.
